(19) United States
(12) Patent Application Publication
(10) Pub. No.: US 2024/0044089 A1
(43) Pub. Date: Feb. 8, 2024

(54) Display Board System Device for Controlling Snow Melting

(71) Applicant: GBSHOPCONTROMAX Co., Ltd., Namyangju-si (KR)

(72) Inventor: Myeon Gab KIM, Seoul (KR)

(21) Appl. No.: 18/226,471

(22) Filed: Jul. 26, 2023

(30) Foreign Application Priority Data
Aug. 8, 2022 (KR) 10-2022-0098304

(51) Int. Cl. E01F 9/40; E01H 5/10; E01F 9/30; G01W 1/06; G09F 9/30; G05B 15/02

(52) U.S. Cl. CPC E01F 9/40; E01H 5/10; E01F 9/30; G01W 1/06; G09F 9/30; G05B 15/02

(57) ABSTRACT

A road display board system device capable of snow melting control includes a detection sensor configured to detect rain and/or snow, a humidity sensor configured to measure a humidity of air, a first temperature sensor configured to measure a temperature of the air, a second temperature sensor configured to measure a temperature of a road surface, a dew point temperature calculator configured to calculate a dew point temperature of the air by matching the humidity of the air and the temperature of the air with a dew point calculation table, a danger time point estimator configured to estimate an icing caution time point and an icing time point, a display configured to display a driving caution guide from the icing caution time point, and a heat supply controller configured to supply heat to the road surface from the icing time point.

### ROSS-REFERENCE TO RELATED APPLICATION(S)

This application claims priority to Korean patent application No. 10-2022-0098304, filed on Aug. 8, 2022, the entire disclosure of which is incorporated herein by reference.

### BACKGROUND

### 1. Field

The present disclosure relates to a road display board system device, and more particularly, to a road display board system device capable of snow melting control of a road and guiding and controlling snow melting of a road in real time.

### 2. Description of the Related Art

In winter when the temperature drops below 0° C., icing often occurs on road surfaces. When such icing occurs, the risk of traffic accidents increases due to vehicle slippage, and therefore, there is a need to quickly remove icing on roads. In particular, the ice on the asphalt road is thin and transparent, so the black asphalt color of the road can be seen as it is, and the ice is called a black ice. This black ice is difficult to detect with the naked eye, and the risk of traffic accidents is very high. Therefore, there is a demand for a method capable of guiding drivers about icing on the road and melting the icy road.

### SUMMARY

Provided is a road display board system device capable of snow-melting control and guiding road icing to drivers in real time.

Provided is a road display board system device capable of snow-melting control and predicting road icing in advance and melting an icy road in real time.

Provided is a road display board system device capable of snow-melting control and enabling even separate external devices to monitor a road icing state.

Provided is a road display board system device capable of snow-melting control and melting an icy road with only a minimum supply of energy.

Additional aspects will be set forth in part in the description which follows and, in part, will be apparent from the description, or may be learned by practice of the presented embodiments.

According to an embodiment of the present disclosure, a road display board system device capable of snow melting control includes a detection sensor configured to detect rain and/or snow, a humidity sensor configured to measure a humidity of air, a first temperature sensor configured to measure a temperature of the air, a second temperature sensor configured to measure a temperature of a road surface, a dew point temperature calculator configured to calculate a dew point temperature of the air by matching the humidity of the air and the temperature of the air with a dew point calculation table, a danger time point estimator configured to estimate, as an icing caution time point, a time point when a temperature of the air measured while the air temperature is decreasing reaches a preset temperature, and estimate, as an icing time point, a time point when the temperature of the road surface reaches 0° C. or less while rain and/or snow has been detected or a time point when the temperature of the road surface reaches the dew point temperature or less while the dew point temperature of the air is or less, a display configured to display a driving caution guide from the icing caution time point, and a heat supply controller configured to supply heat to the road surface from the icing time point.

The road display board system device may further include a central server configured to receive information on the icing caution time point and the icing time point from the danger time point estimator and control respective operations of the display and the heat supply controller according to the received information.

The road display board system device may further include an image obtainer configured to obtain an image of the road surface from the icing caution time point, and a road surface state determiner configured to determine the state of the road surface by analyzing the obtained image, wherein the heat supply controller supplies heat to the road surface when the road surface state determiner determines that the road surface is icy.

The road display board system device may further include an image obtainer configured to obtain an image of the road surface from the icing caution time point, and a road surface state determiner configured to determine the state of the road surface by analyzing the obtained image, wherein the danger time point estimator operates when the road surface state determiner determines that water is present on the road surface.

The danger time point estimator may estimate, as an icing caution release time point, a time point when the temperature of the road surface measured while the air temperature is increasing reaches the preset temperature, the display may stop displaying the driving caution guide from the icing caution release time point, and the heat supply controller may stop supplying heat to the road surface from the icing caution release time point.

A road display board system device capable of snow melting control according to an embodiment of the present disclosure may guide road icing to drivers in real time.

The road display board system device capable of snow melting control according to an embodiment of the present disclosure may predict road icing in advance and melt an icy road in real time.

The road display board system device capable of snow melting control according to an embodiment of the present disclosure may enable even separate external devices to monitor a road icing state.

The road display board system device capable of snow melting control according to an embodiment of the present disclosure may melt an icy road with only a minimum supply of energy.

### BRIEF DESCRIPTION OF THE DRAWINGS

These and/or other aspects will become apparent and more readily appreciated from the following description of the embodiments, taken in conjunction with the accompanying drawings in which:

FIG. 1 is a block diagram of a road display board system device capable of snow melting control according to a first embodiment of the present disclosure;

FIG. 2 illustrates an air temperature variation according to time for explaining operation conditions of a danger time point estimator according to an embodiment of the present disclosure;

FIG. 3 is a view illustrating a guide displayed on a display according to an embodiment of the present disclosure;

FIG. 4 is a block diagram of a road display board system device capable of snow melting control according to a second embodiment of the present disclosure; and

FIG. 5 is a diagram illustrating a process in which a road display board system device capable of snow melting control according to an embodiment of the present disclosure operates together with a central server.

### DETAILED DESCRIPTION

As the present disclosure allows for various changes and numerous embodiments, particular embodiments will be illustrated in the drawings and described in detail in the written description.

However, this is not intended to limit the present disclosure to particular modes of practice, and it is to be appreciated that all changes, equivalents, and substitutes that do not depart from the spirit and technical scope of the present disclosure are encompassed in the present disclosure.

The terms used in the present specification are merely used to describe particular embodiments, and are not intended to limit the present disclosure. An expression used in the singular encompasses the expression of the plural, unless it has a clearly different meaning in the context. In the present specification, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Unless defined differently, all terms used in the description including technical and scientific terms have the same meaning as generally understood by one of ordinary skill in the art to which the present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments of the present disclosure will now be described more fully with reference to the accompanying drawings. In order to facilitate overall understanding in the description of the present disclosure, like reference numerals may refer to like elements, and repeated descriptions of the like elements will be omitted.

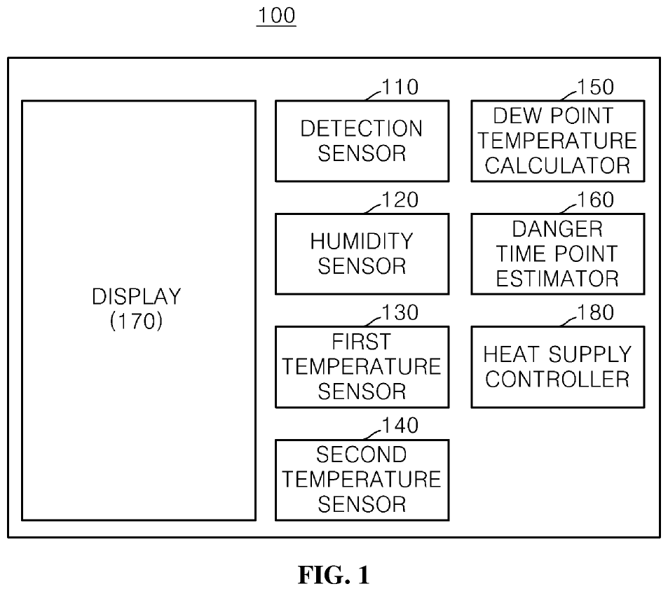

FIG. 1 is a block diagram of a road display board system device capable of snow melting control according to a first embodiment of the present disclosure. An operation of a road display board system device 100 capable of snow melting control according to a first embodiment of the present disclosure will now be described with reference to FIG. 1.

The road display board system device 100 capable of snow melting control according to the first embodiment of the present disclosure may include a detection sensor 110, a humidity sensor 120, a first temperature sensor 130, a second temperature sensor 140, a dew point temperature calculator 150, a danger time point estimator 160, a heat supply controller 170, and a display 180. In this case, the detection sensor 110, the humidity sensor 120, the first temperature sensor 130, the second temperature sensor 140, the dew point temperature calculator 150, the dangerous time point estimator 160, the heat supply controller 170, and the display 180 may be connected to one another through a wired or wireless network, and, when the wired or wireless network is a wireless communication network, the wireless communication network may include cellular communication or short-range communication. For example, the cellular communication may include at least one of long-term evolution (LTE), LTE advance (LTE-A), 5th Generation (5G), code division multiple access (CDMA), wideband CDMA (WCDMA), universal mobile telecommunications system (UMTS), wireless broadband (WiBro), or a global system for mobile communications (GSM). The short-range communication may include at least one of wireless fidelity (WiFi), Bluetooth, near field communication (NFC), and radio frequency identification (RFID). However, a communication method is not limited thereto, and examples of the communication method may include wireless communication technology that is to be developed later. The detection sensor 110, the humidity sensor 120, the first temperature sensor 130, the second temperature sensor 140, the dew point temperature calculator 150, the dangerous time point estimator 160, the heat supply controller 170, and the display 180 may be connected to one another through a wired network, or may be connected to one another by using a method in which a single device transmits or receives internal data.

The road display board system device 100 capable of snow melting control according to the first embodiment of the present disclosure may transmit or receive data to or from other road display board system devices through a wired or wireless communication network, and accordingly, may ascertain and manage temperature and humidity information measured by the other road display board system devices and also road icing-related information estimated by the other road display board system devices. In other words, temperature and humidity information and road icing-related information measured by each road display board system device may be shared with other road display board system devices.

The detection sensor 110 may be located above or outside the road display board system device 100 according to the first embodiment of the present disclosure, and may detect rain and/or snow falling from the sky. When falling raindrops or snow contact a substrate electrode of the detection sensor 110, the detection sensor 110 may detect rain and/or snow by measuring a resistance value that changes according to the area of the contact.

The humidity sensor 120 may be located above or outside the road display board system device 100 according to the first embodiment of the present disclosure, and may measure the humidity of the air. An electrical resistance sensor including a lithium chloride, a polymer, or a ceramic or a capacitive sensor including a polymer may be used as the humidity sensor 120, and absolute humidity or relative humidity of the air may be measured using the humidity sensor 120.

The first temperature sensor 130 may be located above or outside the road display board system device 100 according to the first embodiment of the present disclosure, and may measure the temperature of the air around the road display board system device 100. The measurable range of the first temperature sensor 130 may vary depending on the performance of the first temperature sensor 130 and the location of the road display board system device 100 according to the first embodiment.

The second temperature sensor 140 may measure the temperature of the surface of a road located outside and near the road display board system device 100 according to the first embodiment of the present disclosure. A resistance temperature detector (RTD) temperature sensor using characteristics that resistance changes according to temperature, a thermocouple temperature sensor that detects temperature by using a thermoelectric effect, a contact temperature sensor that measures the temperature by contacting a road surface to be measured (such as, a thermistor temperature sensor including a temperature sensing element made of a material showing a large change in proportion to a small change in temperature), or a non-contact temperature sensor that measures the temperature without contacting a road surface (such as, an infrared temperature sensor that measures the amount of radiation emitted from the road surface) may be used as the second temperature sensor 140, and the temperature of the road surface may be measured using the second temperature sensor 140. In this case, the location of the road surface to be measured for temperature may be determined through analysis of road icing data and/or traffic accident location data. In more detail, the road display board system device 100 according to the first embodiment may ascertain a correlation between statistical data on the locations of roads where icing frequently occurs and statistical data on locations where traffic accidents frequently occur by making the statistical data correspond to regions, time, weather, and a traffic volume, and then may determine the priority of each region in the order of high probability of occurrence of icing according to the correlation. The second temperature sensor 140 may determine the location of the road surface that is to be measured, in consideration of the aforementioned priorities. In this case, the location of the road surface may be at least one, and the priority of measurement may be set in advance or may be changed later.

The dew point temperature calculator 150 may calculate a dew point temperature of the air by matching the humidity of the air measured through the humidity sensor 120 and the temperature of the air measured through the first temperature sensor 130 with a dew point calculation table. The dew point refers to a temperature when the air is saturated and thus vapor condenses, or refer to a temperature when unsaturated air is saturated when being cooled and thus condensation begins. Thus, this dew point varies depending on the temperature. Because the dew point calculation table shows the dew point of each temperature by matching an air temperature and a relative humidity, the dew point temperature calculator 150 may calculate the dew point temperature of the air by matching the humidity of the air measured through the humidity sensor 120 and the temperature of the air measured through the first temperature sensor 130 with this dew point calculation table.

The danger time point estimator 160 may estimate, as an icing caution time point, a time point when the air temperature measured while the air temperature is decreasing reaches a preset temperature.

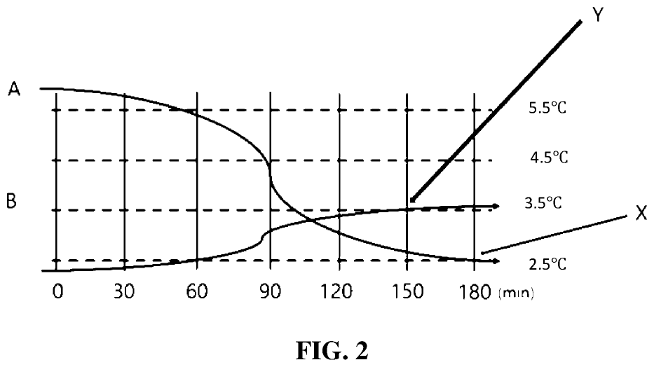

FIG. 2 illustrates an air temperature variation according to time for explaining operation conditions of a danger time point estimator according to an embodiment of the present disclosure. An operation of the danger time point estimator 160 will now be described with reference to FIGS. 1 and 2. The first temperature sensor 130 may measure the air temperature at regular time intervals, and the danger time point estimator 160 may ascertain whether the air temperature rises or falls through an air temperature variation measured at regular time intervals. As shown in FIG. 2, the first temperature sensor 130 may measure the temperature of the air every 30 minutes, and, when the temperature measured every 30 minutes continues to decrease as indicated by “A”, may ascertain that the air temperature decreases. When the temperature measured every 30 minutes continues to increase as indicated by “B”, the first temperature sensor 130 may ascertain that the air temperature increases. The temperature measurement interval is not limited to 30 minutes, and may be set differently according to weather conditions. For example, because the air temperature may change rapidly when weather conditions are not good, such as a snowy or rainy weather or a very cold weather, the temperature measurement interval may be shortened.

FIG. 2 shows a case where the number of temperature measurements is 7 times (0 minute, 30 minutes, 60 minutes, 90 minutes, 120 minutes, 150 minutes, and 180 minutes), but the air temperature measurement is needed to ascertain whether the air temperature falls or rises. Thus, as long as a decrease or increase in the air temperature can be ascertained, the number of temperature measurements is not particularly limited. For example, in a situation where the sun does not rise, a decrease in air temperature may be ascertained with only two or three measurements, and, in a state where the sun rises, an increase in air temperature may be ascertained with only two or three measurements.

The danger time point estimator 160 may estimate, as an icing caution time point, a time point X when the air temperature when the air temperature decreases as indicated by “A” of FIG. 2 reaches 2.5° C., which is a preset temperature. In an embodiment of the present disclosure, 2.5° C. is determined as the set temperature. However, embodiments are not limited thereto, and a temperature at which the risk of icing of the road surface may occur, which is equal to or greater than 0° C., may be determined as the set temperature. This temperature may be set differently according to locations of the road display board system device 100 according to the first embodiment in consideration of the probability of icing according to region, time, and weather, and the set temperature may be changed according to weather conditions and time. The danger time point estimator 160 may estimate, as an icing caution section, a road surface section where the temperature of a road surface measured through the second temperature sensor 140 when the air temperature decreases as indicated by “A” of FIG. 2 reaches a temperature lower than the preset temperature. For example, when the preset temperature is 2.5° C., the danger time point estimator 160 may estimate, as the icing caution section, a road surface section where the temperature of the road surface reaches 2° C. or 1.5° C. lower than the preset temperature.

The danger time point estimator 160 may estimate an icing time point by using a result of the detection sensor 110 detecting rain and/or snow and a temperature measured by the second temperature sensor 140, or may estimate the icing time point by using the dew point temperature calculated by the dew point temperature calculator 150 and the temperature measured by the second temperature sensor 140. In more detail, when rain and/or snow is detected by the detection sensor 110, the danger time point estimator 160 may estimate, as the icing time point, a time point when the temperature of the road surface measured by the second temperature sensor 140 reaches 0° C. or less. When the dew point temperature calculated by the dew point temperature calculator 150 is less than or equal to 0° C., the danger time point estimator 160 may estimate, as the icing time point, a time point when the temperature of the road surface measured by the second temperature sensor 140 reaches the calculated dew point temperature. The danger time point estimator 160 may estimate, as an icing caution release time point, a time point Y when the air temperature when the air temperature increases as indicated by “B” of FIG. 2 reaches 3.5° C., which is a preset temperature. In an embodiment of the present disclosure, 3.5° C. is determined as the set temperature. However, embodiments are not limited thereto, and a temperature equal to or higher than a temperature (2.5° C.) for estimating the icing caution time point, as a temperature at which the risk of icing of the road surface is released, which is equal to or greater than 0° C., may be determined as the set temperature. In an embodiment of the present disclosure, the temperature (3.5° C.) at which the risk of icing of the road surface is released is set differently from the temperature (2.5° C.) for estimating the icing caution time point. However, embodiments are not limited thereto, and the temperature (3.5° C.) at which the risk of icing of the road surface is released may be set to be identical with the temperature (2.5° C.) for estimating the icing caution time point.

When the danger time point estimator 160 estimates the icing caution time point, a result of the estimation may be transmitted to the display 170, and, when the danger time point estimator 160 estimates the icing time point, a result of the estimation may be transmitted to the heat supply controller 180. When the danger time point estimator 160 estimates an icing caution release time point, a result of the estimation may be transmitted to the display 170 and the heat supply controller 180.

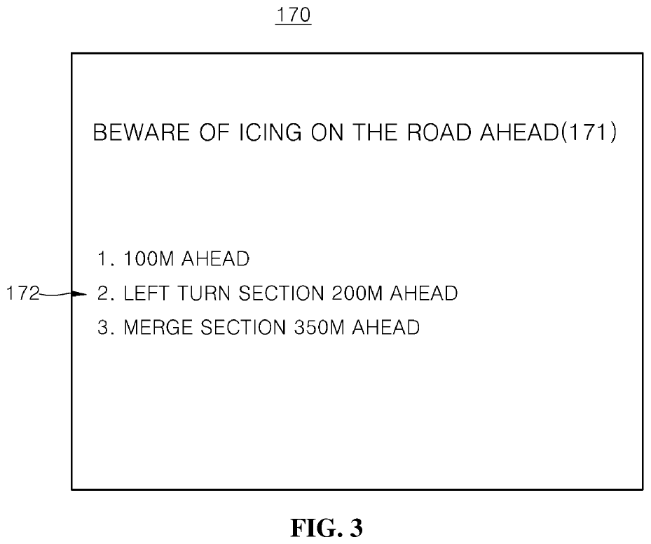

The display 170 may display a driving caution guide from the icing caution time point. FIG. 3 is a view illustrating a guide displayed on a display according to an embodiment of the present disclosure. As shown in FIG. 3, the display 170 may display an icing caution guide 171 from the icing caution time point estimated by the danger time point estimator 160. The danger time point estimator 160 may estimate an icing caution section 172 by comparing the temperature of the road surface measured by the second temperature sensor 140 with the preset temperature, and, in response to such data, the display 170 may additionally display the icing caution section 172. The display 170 may stop displaying driving caution guides (the icing caution guide 171 and the icing caution section 172) from a time point when information about the icing caution release time point is received from the danger time point estimator 160. Therefore, the display 170 may guide the danger only in an icing danger section.

The heat supply controller 180 may supply heat to the road surface by sending a control

signal to a heat supply device located on the road surface. The heat supply device is located on the road surface, and the type of heat supply device is not limited as long as it is capable of removing icing on the road surface through heat supply. For example, a device capable of dissipating heat to the outside, such as a hot wire or a heater, may be used as the heat supply device. The heat supply controller 180 may supply heat to the road surface estimated to be icy by sending the control signal from an icing time point estimated by the danger time point estimator 160, thereby removing the ice on the road surface. The heat supply controller 180 may send the control signal to the heat supply device located on the road surface to stop supplying heat to the road surface from the time point of receiving the information about the icing caution release time point from the danger time point estimator 160. Therefore, the icy road may be melted with a minimum supply of energy.

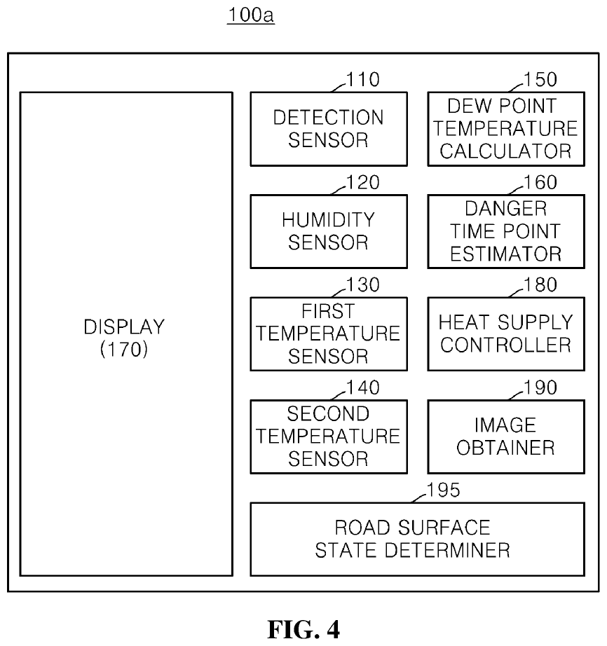

FIG. 4 is a block diagram of a road display board system device 100a capable of snow melting control according to a second embodiment of the present disclosure. Compared to the road display board system device 100 according to the first embodiment of the present disclosure, the road display board system device 100a according to the second embodiment of the present disclosure may further include an image obtainer 190 and a road surface state determiner 195. An operation of the road display board system device 100a according to the second embodiment of the present disclosure will now be described focusing on the additional components, namely, the image obtainer 190 and the road surface state determiner 195 of FIG. 4.

The image obtainer 190 may obtain an image of a road surface. A camera capable of capturing an image may be used as the image obtainer 190, but embodiments are not limited thereto. Any device capable of obtaining an image of a road surface may be used. For example, a device obtaining an image of a road surface through a method of receiving an image obtained by another device located on the road surface or a device obtaining an image of a road surface through a method of receiving an image obtained by another road display board system device may also be used as the image obtainer 190. The image obtainer 190 may obtain an image of the road surface by operating from a time point estimated as the icing caution time point by the danger time point estimator 160.

The road surface state determiner 195 may receive road surface image information from the image obtainer 190 and analyze the received road surface image information to determine the state of the road surface. The road surface state determiner 195 has various types of images related to the states of the road surface, and may analyze the state of the road surface through a method of comparing and matching the state of the road surface with these images. For example, the road surface state determiner 195 may include various images of a state in which water is present on the road surface, various images of a state in which water is not present on the road surface, various images of a state in which the road surface is icy, various images of snow on the road surface, and various images of a state in which the frozen road surface is thawed, and may determine the state of the road surface through a method of comparing and matching the image obtained by the image obtainer 190 with these images.

When the road surface state determiner 195 determines that the road surface is icy, the road surface state determiner 195 may transmit a result of the determination to the heat supply controller 180, and, in response to the result of the determination, the heat supply controller 180 may supply heat to the road surface determined to be icy.

When the road surface state determiner 195 determines that water is present on the road surface, the road surface state determiner 195 may transmit a result of the determination to the danger time point estimator 160, and, in response to the result of the determination, the danger time point estimator 160 may operate.

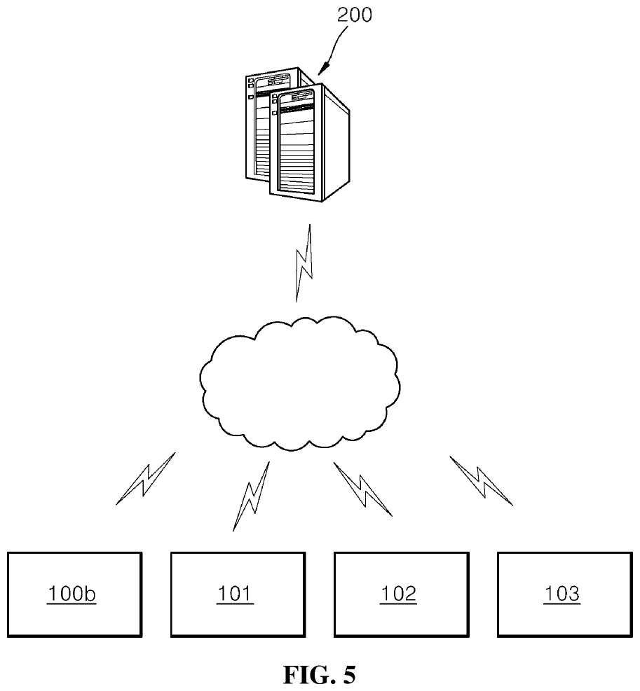

FIG. 5 is a diagram illustrating a process in which a road display board system device capable of snow melting control according to an embodiment of the present disclosure operates together with a central server. As shown in FIG. 5, a road display board system device 100b according to an embodiment of the present disclosure may be connected to a central server 200 and other road display board system devices 101, 102, and 103 through a network. Therefore, data obtained and calculated by each road display board system device may be shared with other road display board system devices and the central server 200. Accordingly, icing state information of the surface of a road in a specific region may be displayed in the form of a caution guide on respective displays of not only a road display board system device located in the specific region but also a road display board system device located in another region of the road.

The central server 200 receiving all pieces of information and data from each road display board system device may control an operation of each road display board system device, based on the received information and data. In more detail, when receiving information on the icing caution time point and the icing time point from the danger time point estimator 160 of the road display board system device 100, the central server 200 may control respective operations of the display 170 and the heat supply controller 180 of the road display board system device 100 according to the received information. Therefore, even the central server 200, which is a separate external device, may monitor the road icing state and control the road display board system device 100. A computing device including at least one of a memory, an input/output interface module, and a communication module, each of which is connected to a bus to perform communication or is connected around a processor, may be used as the central server 200. The processor may be implemented in various types such as an application processor (AP), a central processing unit (CPU), a graphics processing unit (GPU), and the like, and may be any semiconductor device that executes instructions stored in a memory. Therefore, a device such as a smartphone, in addition to a general server, may also be used as the central server 200. Because the central server 200 is able to receive the information on the icing caution time point and the icing time point, even the smartphone may check the information on the icing caution time point and the icing time point.

An embodiment of the invention may be implemented as a non-transitory computer-readable medium in which a method implemented by a computer or instructions executable by the computer are recorded. When instructions readable by a computer are executed by a processor, the instructions readable by a computer may perform a method according to at least one aspect of the present disclosure.

As above, embodiments of the present disclosure have been disclosed in the drawings and the specification. The terminology used herein is for the purpose of describing embodiments of the present disclosure only and is not intended to be limiting of the present disclosure. Therefore, it will be understood by those skilled in the art that various changes in form and details may be made therein without departing from the spirit and scope of the present disclosure as defined by the appended claims.

What is claimed is:

1. A road display board system device capable of snow melting control, comprising:
a detection sensor configured to detect rain and/or snow;
a humidity sensor configured to measure a humidity of air;
a first temperature sensor configured to measure a temperature of the air;
a second temperature sensor configured to measure a temperature of a road surface;
a dew point temperature calculator configured to calculate a dew point temperature of the air by matching the humidity of the air and the temperature of the air with a dew point calculation table;
a danger time point estimator configured to estimate, as an icing caution time point, a time point when a temperature of the air measured while the air temperature is decreasing reaches a preset temperature, and estimate, as an icing time point, a time point when the temperature of the road surface reaches 0° C. or less while rain and/or snow has been detected or a time point when the temperature of the road surface reaches the dew point temperature or less while the dew point temperature of the air is 0° C. or less;
a display configured to display a driving caution guide from the icing caution time point; and
a heat supply controller configured to supply heat to the road surface from the icing time point.

2. The road display board system device of claim 1, further comprising a central server configured to receive information on the icing caution time point and the icing time point from the danger time point estimator, and control respective operations of the display and the heat supply controller according to the received information.

3. The road display board system device of claim 1, further comprising:
an image obtainer configured to obtain an image of the road surface from the icing caution time point; and
a road surface state determiner configured to determine the state of the road surface by analyzing the obtained image,
wherein the heat supply controller supplies heat to the road surface when the road surface state determiner determines that the road surface is icy.

4. The road display board system device of claim 1, further comprising:
an image obtainer configured to obtain an image of the road surface from the icing caution time point; and
a road surface state determiner configured to determine the state of the road surface by analyzing the obtained image,
wherein the danger time point estimator operates when the road surface state determiner determines that water is present on the road surface.

5. The road display board system device of claim 1, wherein the danger time point estimator estimates, as an icing caution release time point, a time point when the temperature of the road surface measured while the air temperature is increasing reaches the preset temperature, the display stops displaying the driving caution guide from the icing caution release time point, and the heat supply controller stops supplying heat to the road surface from the icing caution release time point.
